(19) United States
(12) Patent Application Publication
(10) Pub. No.: US 2023/0153612 A1
(43) Pub. Date: May 18, 2023

(54) PRUNING COMPLEX DEEP LEARNING MODELS BASED ON PARENT PRUNING INFORMATION

(71) Applicant: NVIDIA Corporation, Santa Clara, CA (US)

(72) Inventors: Yu Wang, Winchester, MA (US); Farzin Aghdasi, East Palo Alto, CA (US); Parthasarathy Sriram, Los Altos Hills, CA (US)

(21) Appl. No.: 18/056,559

(22) Filed: Nov. 17, 2022

Related U.S. Application Data
(60) Provisional application No. 63/281,045, filed on Nov. 18, 2021.

(51) Int. Cl. G06N 3/08

(52) U.S. Cl. CPC G06N 3/08

(57) ABSTRACT

When visiting a child node in a graph corresponding to a deep learning model to analyze the child node for pruning in the deep learning model, data identifying pruning information corresponding to one or more parent nodes may be determined and used to access the pruning information. For example, a list of parent nodes of the parent node may be used to access the pruning information for the visit to the child node. The graph may be explored using recursion to iteratively visit nodes to determine portions of pruning information for pruning a node where a portion of the pruning information determined for prior visits to the nodes may be reused. A layer of the deep learning model including multiple dependent convolutions may be pruned by treating each convolution as a separate node and/or layer.

### CROSS-REFERENCE TO RELATED APPLICATIONS

This application claims the benefit of U.S. Provisional Application No. 63/281,045, filed on Nov. 18, 2021, which is hereby incorporated by reference in its entirety.

### BACKGROUND

When using a deep learning model in deployment, it's important that the model is both accurate and efficient. Neural network pruning techniques can reduce the number of parameters in trained networks substantially and improve the computational performance of inferencing operations without compromising accuracy. For example, entire neurons may be pruned from fully connected layers or entire filters from convolutional layers. Various information may be needed in order to determine what portions of a deep learning model can be pruned. The information may need to account for not only constraints and characteristics of all direct parent nodes of the layer—of which there may be multiple—but also corresponding information for any parent layers of those parents, extending back to the input layers of the model. For example, when layers of the model are pruned, the remaining portions of the layers may need to form channels that connect to compatible inputs and outputs extending to the input layers of the model, such that each parent layer may need to be considered for each layer.

Conventional approaches to pruning a deep learning model may determine, for each particular layer of the model, all of the information needed to prune connections to the layer. To determine the information for a given layer, a process may be used where the information is recursively determined for each connected upstream layer. Thus, the computing requirements and time required to determine the information may have an exponential relationship with the number of layers and connections in the model. While these conventional approaches may be sufficient to prune simple models with a limited number of dependencies and layers, the computing resources required to prune a more complex model in a reasonable amount of time may be prohibitive. Additionally, conventional approaches to pruning a deep learning model may not be able to handle certain layers that include multiple dependent convolutions, such as separable convolutional layers, and may not be able to handle convolutional layers which have inputs form multiple layers.

### SUMMARY

Embodiments of the present disclosure relate to pruning complex deep learning models based on reusing pruning information from earlier (parent) layers in the neural network. In particular, the disclosure relates to approaches for analyzing one or more connections to a layer for pruning based at least on reusing at least some pruning information determined for one or more parent nodes of the layer.

In contrast to conventional approaches, such as those described above, when visiting a child node in a graph corresponding to a deep learning model to determine pruning information for the child node (e.g., a list of prunable parent nodes of the child node), data identifying pruning information corresponding to one or more parent nodes may be incorporated into the pruning information for the child node. Thus, the pruning information need not be re-identified and/or re-generated by iteratively revisiting each parent node for each node being evaluated for pruning. In at least one embodiment, the data identifying the pruning information may represent, at least in part, a list of one or more parent nodes of the node being evaluated (e.g., a list of prunable parent nodes of the node). The list of one or more parent nodes of the parent node may be used to access the pruning information for the child node. In at least one embodiment, the graph may be explored recursively to iteratively visit nodes to determine portions of pruning information for pruning a node. One or more iterations of the recursion may be skipped or made more efficient by reusing a portion of the pruning information determined for one or more prior visits to one or more of the nodes. In further respects, layers of a deep learning model including multiple dependent convolutions, such as separable convolutional layers, may be pruned by treating each convolution as a separate node and/or layer. Further, a convolutional layer that has inputs from multiple layers, and the inputs themselves, may be pruned by treating the convolutional layer as an element-wise layer (e.g., by ensuring input channels from multiple layers, if pruned, have the same number of remaining channels per layer).

### BRIEF DESCRIPTION OF THE DRAWINGS

The present systems and methods for pruning complex deep learning models based on reusing parent pruning information are described in detail below with reference to the attached drawing figures, wherein:

FIG. 1 is a data flow diagram illustrating an example process for pruning a deep learning model, in accordance with at least one embodiment of the present disclosure;

FIG. 2 illustrates an example of a deep learning model that may be pruned, in accordance with some embodiments of the present disclosure;

FIG. 3 illustrates an example of a layer of a deep learning model that may be pruned, in accordance with some embodiments of the present disclosure;

FIG. 4 is a flow diagram showing a method for exploring a graph corresponding to a deep learning model based on reusing data, determined for a visit to a node, that identifies pruning information for the node, to access the pruning information for analyzing another node for pruning, in accordance with some embodiments of the present disclosure;

FIG. 5 is a flow diagram showing a method for exploring a graph corresponding to a deep learning model based on using a list of one or more parents, generated for a visit to a node, that indicates pruning information for the node, to access the pruning information for analyzing another node for pruning, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

The present disclosure relates to pruning complex deep learning models based on parent pruning information. In particular, the disclosure relates to approaches for analyzing one or more connections to a layer for pruning based at least on reusing at least some pruning information determined for one or more parent nodes of the layer.

In accordance with one or more embodiments, when visiting a child node in a graph corresponding to a deep learning model to determine pruning information for the child node (e.g., a list of prunable parent nodes of the child node), data identifying pruning information corresponding to one or more parent nodes may be incorporated into the pruning information for the child node. Thus, the pruning information need not be re-identified and/or re-generated by revisiting each parent node for each node that is to be analyzed for pruning.

In at least one embodiment, the data identifying the pruning information may represent, at least in part, a list of one or more parent nodes of the parent node (e.g., a list of prunable parent nodes of the node). The list of one or more parent nodes of the parent node may be included in a list of one or more parent nodes of the child node used to access the pruning information for analyzing one or more connections to the child node for pruning.

In at least one embodiment, the graph may be explored using recursion to iteratively visit nodes to determine portions of pruning information for pruning a node. One or more iterations of the recursion may be skipped or made more efficient by reusing a portion of the pruning information determined for one or more prior visits to one or more of the nodes. For example, a node of the graph may be explored using a recursive graph traversal algorithm to determine pruning information for pruning the node. The recursive graph traversal algorithm may begin with a visit to the node, and recursively call itself to visit a parent node of determine a portion of the pruning information that corresponds to the parent node. In at least one embodiment, one or more recursive calls may be skipped based at least on determining the parent node has already been visited (e.g., has been fully explored in one or more passes through one or more nodes of the deep learning model) when exploring the node or a different node, and based on the determining, the pruning information for the parent may be used to evaluate the node for pruning.

In further respects, layers of deep learning model including multiple dependent convolutions, such as separable convolutional layers, may be pruned by treating each convolution as a separate node and/or layer. Further, a convolutional layer that has multiple inputs may be pruned (as well as the inputs) by treating the convolutional layer as an element-wise layer. For example, disclosed approaches may ensure input channels from multiple layers, if pruned, have the same number of remaining channels per layer, allowing for those inputs to be pruned as well as the convolutional layer.

As used herein, a prunable node and/or layer may refer to a node and/or layer that may be pruned (e.g., has a prunable kernel). Examples of a non-prunable node and/or layer may include a layer such as an activation layer, an input layer, a layer designated as non-prunable, a layer that is not supported by the software for pruning, a layer that does not include weights, and/or a layer whose pruning would violate one or more system or user defined pruning criteria. When a node is prunable, kernel of the node may be pruned to produce a set of one or more outputs. In one or more embodiments, a prunable node and/or layer may receive one or more inputs from one or more layers. To prune a convolutional layer, for example, a list of one or more inputs (e.g., input indices) from one or more layers may be used to prune the layer, and a list of one or more outputs (e.g., one or more kernel output indices) may be recoded.

However, when a node and/or layer has inputs from multiple nodes and/or layers, pruning the inputs to the node may need to account for combining input connections to the node, such that the resultant deep learning model functions properly. For example, if an element-wise layer is to perform an addition using inputs from two convolutional layers, after pruning those two convolutional layers, inputs to the element-wise layer may need to match across the two convolutional layers (e.g., the same number of inputs and matching input indices) for the addition operation. The process of matching inputs from multiple layers may be referred to as equalization and may include, for example, using an intersection and/or union between the parent layers to match the inputs across the layers. A similar situation may arise for other types of nodes and/or layers that have inputs from multiple nodes and/or layers, such as convolutional layers.

Thus, for a child node that has inputs from multiple parent nodes and/or layers, pruning information for each of the parent nodes may be needed (e.g., in order to match channel indices) when analyzing inputs to the child node for pruning. For example, pruning information from at least the nearest prunable parent nodes may be needed to determine inputs that should be analyzed for equalization. Thus, the graph of the deep learning model may be explored for the child node to determine the relevant parent nodes and/or pruning information for those parents, for use in analyzing the inputs to the child node for pruning. For example, a list of the nearest prunable parent nodes may be determined for the child node for use in pruning. In one or more embodiments, where the child node is a parent of another node, rather than fully exploring the graph for the other node, the list of nearest prunable parent nodes and/or other pruning information may be reused (e.g., the list of nearest one or more prunable parent nodes may be incorporated into a list of nearest one or more prunable parent nodes for the other node). While a list is described as a list of nearest prunable parent nodes (e.g., per branch), in one or more embodiments, the list may or may not include the nearest prunable parent node for one or more branches. In at least one embodiment, the list may exclude convolutional layers (and/or other layer types) that have inputs from multiple layers, despite those layers being prunable. However, in one or more embodiments, the list may include convolutional layers (and/or other layer types) that have inputs from multiple layers.

The systems and methods described herein may be used for a variety of purposes, by way of example and without limitation, these purposes may include systems or applications for online multiplayer gaming, machine control, machine locomotion, machine driving, synthetic data generation, model training, perception, augmented reality, virtual reality, mixed reality, robotics, security and surveillance, autonomous or semi-autonomous machine applications, deep learning, environment simulation, data center processing, conversational AI, light transport simulation (e.g., ray tracing, path tracing, etc.), collaborative content creation for 3D assets, digital twin systems, cloud computing and/or any other suitable applications.

Disclosed embodiments may be comprised in a variety of different systems such as systems for participating on online gaming, automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for generating or maintaining digital twin representations of physical objects, systems implemented at least partially using cloud computing resources, and/or other types of systems.

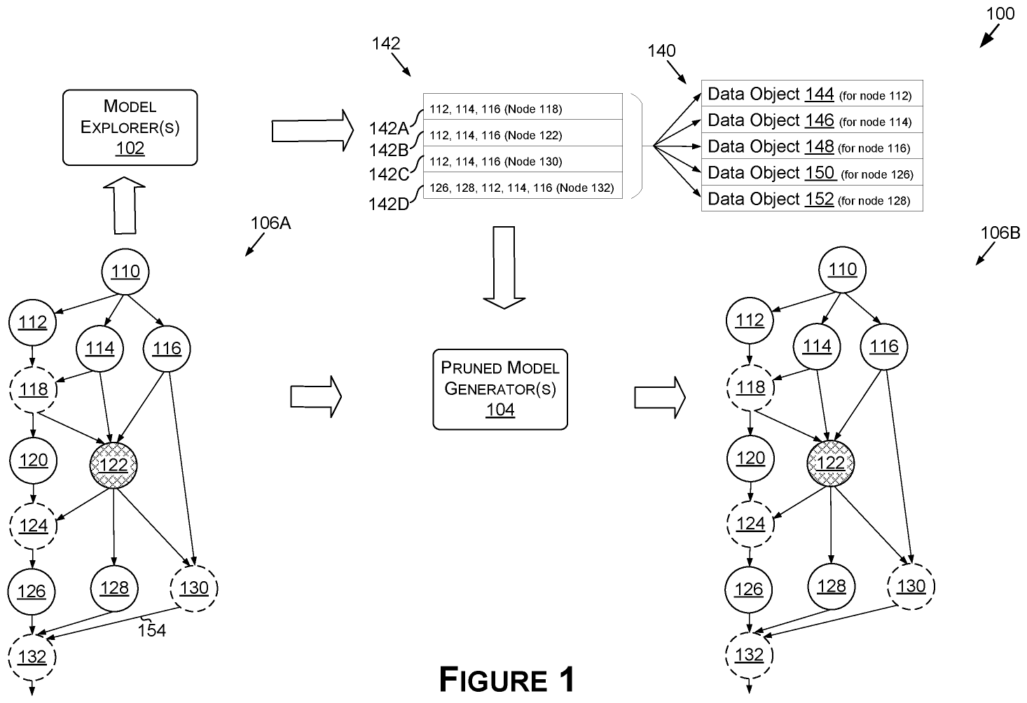

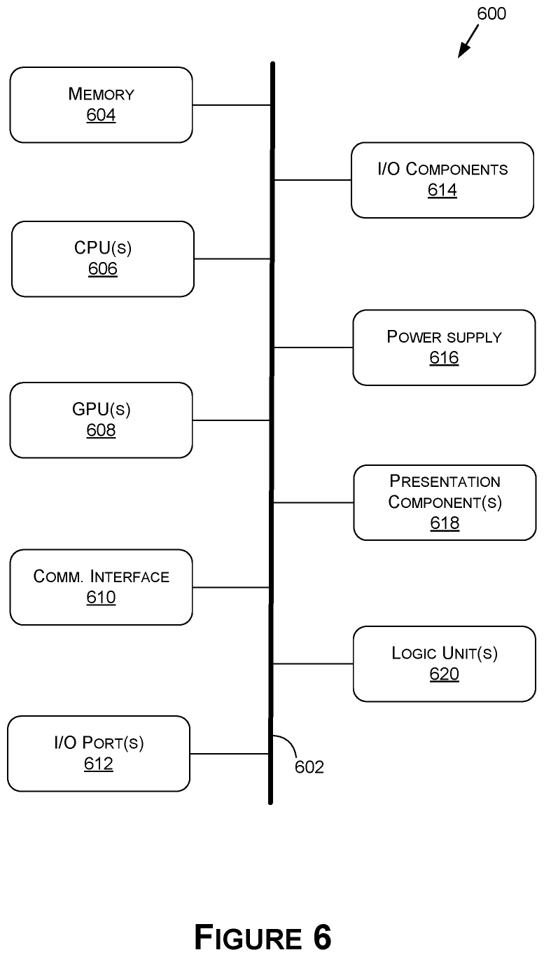

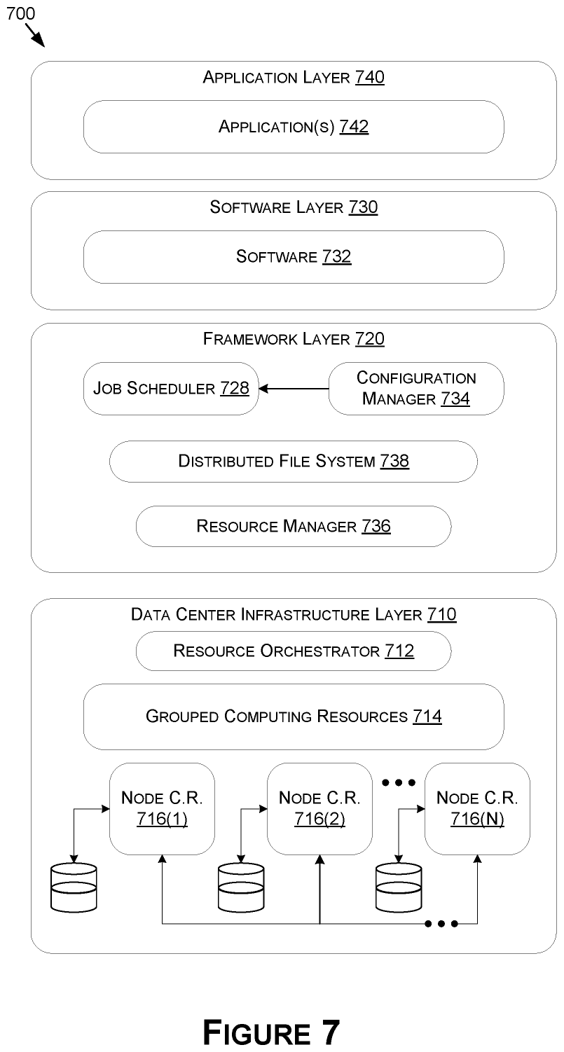

FIG. 1 is a data flow diagram illustrating an example process 100 for pruning a deep learning model 106A (also referred to as “model 106A”), in accordance with at least one embodiment of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In at least one embodiment, the systems, methods, and processes described herein may be executed using similar components, features, and/or functionality to those of example computing device 600 of FIG. 6 and/or example data center 700 of FIG. 7.

The process 100 may be implemented using, among additional or alternative components, one or more model explorers 102 and one or more pruned model generators 104.

At a high level, the process 100 may include the model explorer 102 receiving one or more inputs, such as data representing one or more deep learning models 106A, and generating one or more outputs, such as pruning information for the one or more deep learning models 106A, which may be stored in, for example, one or more data objects 140 and/or one or more lists 142. The process 100 may also include the pruned model generator 104 receiving one or more inputs, such as the one or more deep learning models 106A, the data objects 140, and the lists 142, and generating one or more outputs—such as a pruned version(s) 106B of the one or more deep learning models 106A (also referred to as “pruned model 106B”)—from the one or more inputs.

In at least one embodiment, the deep learning model 106A may be provided to the model explorer 102 using a representation including a graph having nodes corresponding to one or more layers of the deep learning model 106A and one or more edges corresponding to one or more connections between the one or more layers of the deep learning model 106A. For example, the deep learning model 106A is shown as including nodes 110, 112, 114, 116, 118, 120, 122, 124, 126, 128, 130, and 132. In at least one embodiment, each node may correspond to a respective layer of the deep learning model 106A. In at least one embodiment, each edge may correspond to one or more connections between the layers. For example, an edge 154 may correspond to one or more connections between a layer corresponding to the node 130 and a layer corresponding to the node 132. As indicated in FIG. 1, the edge 154 corresponds to one or more inputs to a layer corresponding to the node 132 from a layer corresponding to the node 130. In at least one embodiment, the edge 154 may form a portion of one or more channels between an input layer(s) of the deep learning model 106A (e.g., corresponding to the node 110) and the node 132.

A layer for a node may include any suitable type of layer of a deep learning model. In at least one embodiment, a layer takes as input one or more tensors and outputs one or more tensors. A layer may correspond to a computation performed using the input and one or more parameters to effectuate the computation, such as one or more weights. Non-limiting examples of a layer include a convolutional layer, a separable convolutional layer, a depthwise convolutional layer, a transposed convolutional layer, a pooling layer, a max pooling layer, an average pooling layer, a global max pooling layer, a global average pooling layer, a recurrent layer, a Long Short-Term Memory (LSTM) layer, a Gate Recurrent Unit (GPU) layer, a Recurrent Neural Network (RNN) layer, a time distributed layer, a bidirectional layer, a convolutional LSTM layer, a preprocessing layer, a normalization layer, a regularization layer, an attentional layer, a reshaping layer, a merging layer, a locally-connected layer, an activation layer, an input layer, or an output layer. A layer may comprise a 1-dimensional (1D), 2-dimensional (2D), or 3-dimensional (3D) layer, as examples.

In at least one embodiment, the representation of the deep learning model 106A may be provided using a deep learning framework. For example, the deep learning model 106A may be defined using an application programming interface (API) of a deep learning framework.

The deep learning model 106A may be trained to perform any of a variety of tasks. Non-limiting examples of the tasks include one or more tasks for online multiplayer gaming, machine control, machine locomotion, machine driving, synthetic data generation, model training, perception (e.g., visual perception), augmented reality, virtual reality, mixed reality, robotics, security and surveillance, autonomous or semi-autonomous machine applications, deep learning, environment simulation, data center processing, conversational AI, light transport simulation (e.g., ray tracing, path tracing, etc.), collaborative content creation for 3D assets, cloud computing, smart area monitoring, simulation, generating or maintaining digital twin representations of physical objects, and/or any other suitable applications.

The model explorer 102 and the pruned model generator 104 may be used to remove one or more parameters from the deep learning model 106A to produce the pruned model 106B having a reduced size while maintaining the functionality and accuracy of the deep learning model 106A. In at least one embodiment, additional training may be performed on the pruned model 106B (e.g., using the same dataset used to train the deep learning model 106A).

In at least one embodiment, the model explorer 102 may be configured to determine and/or identify at least some pruning information for the nodes of the deep learning model 106A. The pruned model generator 104 may use at least some of the determined and/or identified pruning information to generate the pruned model 106B. For example, the pruning information determined by the model explorer 102 and used by the pruned model generator 104 may represent and/or indicate one or more of the connections and/or parameters selected by the model explorer 102 for pruning and/or retaining, one or more one or more prunable layers and/or nodes of the deep learning model 106A, one or more prunable parent nodes for a node and/or layer, and/or a list(s) (e.g., an ordered list) of parent nodes (e.g., prunable parent nodes) for a node and/or layer.

By way of example, and not limitation, the pruning information may include lists 142. For example, a list 142 may include a list of parent nodes (e.g., one or more prunable parent nodes) of one or more layers and/or nodes in the deep learning model 106A. In at least one embodiment, a list 142 may include a list of parent nodes for a particular node. For example, the lists 142 include a list 142A for the node 118, a list 142B for the node 122, a list 142C for the node 130, and a list 142D for the node 132. As shown, each list of lists 142 may include parent nodes of a corresponding node. The lists 142 may include more or fewer nodes than what is shown. In at least one embodiment, the lists 142 include lists of prunable parent nodes (a node and/or layer) to the nodes and/or layers. For example, each list 142 may include a list of the nearest prunable parent nodes of a corresponding node.

The lists 142 may be stored in various ways, such as using one or more dictionaries, arrays, linked lists, queues, hash maps, stacks, pointers, and/or variables. In at least one embodiment, the lists 142 may be used by the model explorer 102 and/or the pruned model generator 104 to store and/or access pruning information for nodes and/or layers corresponding to the lists 142. For example, the lists 142 may include pointers and/or information used to determine pointers to sets of one or more data objects 140 storing one or more portions of pruning information for one or more nodes and/or layers. Thus, data representing a list 142 may be an example of data identifying pruning information stored in a set of one or more data objects, as described herein. In one or more embodiments, a list may include pointers and/or information used to determine pointers to one or more other lists. For example, a list for a child node may point to a list(s) for a parent node(s).

In at least one embodiment, a list 142 may include and/or be used to determine a pointer for each node in the list 142, such that only one data object 140 need be stored for each node and/or layer. In one or more embodiments, the lists 142 may be stored using ordered key-value pairs, where the keys may include or correspond to node and/or layer names or identifiers and the values may store at least some of the pruning information. For example, the lists 142 may be stored using dictionaries where node names are used as keys.

As described herein, at least some of the pruning information may be stored using the data objects 140. Each data object 140 may store one or more portions of the pruning information for one or more layers and/or nodes (e.g., determined for a visit to that node(s)). In at least one embodiment, each data object 140 stores the pruning information for a corresponding node. For example, a data object 144 may store pruning information for the node 112, a data object 146 may store pruning information for the node 114, a data object 148 may store pruning information for the node 116, a data object 150 stores pruning information for the node 126, and a data object 152 may store pruning information for the node 128.

In at least one embodiment, a portion of pruning information stored for a node may indicate and/or represent any of the various information used to analyze the node for pruning and/or one or more results of the analysis. Examples of the information include a set of one or more connections to the node to retain and/or prune, one or more pruning thresholds for the node (e.g., one or more threshold values representing a limit on a quantity of kernels to prune from the node), and/or other pruning information described herein. In at least one embodiment, at least some of the pruning information stored for the node may be specific to the node. Using the list 142 and/or other data identifying the portions or pruning information for one or more prunable parent nodes of a node, the information may be readily reused when analyzing the node for pruning.

In at least one embodiment, the pruned model generator 104 uses the pruning information to generate at least a portion of the pruned model 106B in accordance with the pruning information. For example, generating the pruned model 106B may include one or more of the pruned model generator 104 removing one or more selected connections and/or parameters from the deep learning model 106A, reforming and/or determining one or more weights and/or weight matrices and/or portions thereof for one or more layers, and reloading one or more of the weights and/or weight matrices to one or more layers based on selections made using the model explorer 102. The pruned model generator 104 may generate the pruned model generator 106B in the same and/or a different format than the deep learning model 106a. In at least one embodiment, the pruned model generator 104 operates, at least partially, in parallel with the model explorer 102 determining and/or generating pruning information. In at least one embodiment, the pruned model generator 104 operates, at least partially, in serial with the model explorer 102 determining and/or generating pruning information. As non-limiting examples, the pruned model 106B may generate one or more portions of the pruned model 106B as corresponding pruning information becomes available or may wait for all of the pruning information to become available before generating the pruned model 106B .

In at least one embodiment, the model explorer 102 may determine and/or identify at least a portion of the pruning information based at least on exploring the graph corresponding to the deep learning model 106A. Various graph exploration algorithms may be used. In at least one embodiment, the model explorer 102 may explore each node of the deep learning model 106A using a recursive graph traversal algorithm (e.g., initiated on any number of the nodes individually in parallel and/or serially to explore that node).

To explore a node, the model explorer 102 may visit the node to determine and/or identify pruning information and use the pruning information to analyze the node for pruning. In at least one embodiment, analyzing the node for pruning may include selecting one or more connections and/or parameters to prune from and/or retain in the deep learning model 106A. In at least one embodiment, data indicating results of the analysis may be stored, at least in part, in a data object 140 for the node (e.g., data representing one or more remaining output channel indices).

In at least one embodiment, analyzing a node for pruning may include determining not to prune the node. In at least one embodiment, analyzing a node for pruning may include evaluating one or more pruning thresholds to the node. In at least one embodiment, analyzing the node for pruning may include performing equalization, where input connections to the node from at least two parent nodes may be combined, such as using an intersection or union.

The determined and/or identified pruning information for a visit to a node may include pruning information for the current node being explored and/or one or more parent nodes for which pruning information is to be used to select the connection(s) and/or parameter(s) to prune from and/or retain in the deep learning model 106A for the node. For example, for a visit to the node 132, the model explorer 102 may use the list 142D to identify and access the data objects 140 to analyze one or more connections corresponding to the edge 154 for pruning. By way of example, and not limitation, the model explorer 102 may select for the edge 154 one or more connections to retain based at least on selections made for edges corresponding to one or more parent nodes, such as the nearest prunable parent nodes of the node 132.

In at least one embodiment, the visit to a node may include determining data identifying at least some of the pruning information for the node, such as pruning information used to analyze the node for pruning (e.g., for the visit). For example, the visit for a node may include generating and/or identifying at least a portion of a list 142 for the node. As a more specific example, for a visit to the node 132, the list 142D may be generated and may be used to identify pruning information to analyze the node 132.

In FIG. 1, the nodes 132, 130, 124, and 118 that are indicated using dashed lines are examples of nodes that include element-wise layers. The nodes 110, 112, 114, 116, 120, 126, 128, and 130 that are indicated using solid lines and no shading are examples of noes that have one or more inputs from a single layer and include a convolutional layer. The node 122 that is indicated using a sold line and shading is an example of a node that has inputs from multiple nodes and includes a convolutional layer. As the node 132 is an element-wise layer, analyzing the node 132 may require pruning information corresponding to the nodes 126, 128, and 130 providing inputs to the node 132 (e.g., retained output indices from pruning those layers for equalization). The nodes 126 and 128 are prunable, and therefore the pruning information from those nodes may be used for analyzing the node 132. However, the node 130 is also an equalization layer such that pruning information for the node 130 may depend on prunable parent nodes of that node. For example, the pruning information for the node 130 may depend on pruning information for the nodes 122 and 116. The node 116 is prunable, and therefore the pruning information for the node 116 may be used for analyzing the node 130. However, the node 122 is has inputs from multiple nodes such that pruning information for the node 122 may depend on prunable parent nodes of that node. For example, the pruning information for the node 122 may depend on pruning information for the nodes 118, 114, and 116. The nodes 114 and 116 are prunable, and therefore the pruning information for the nodes 114 and 116 may be used for analyzing the node 122. However, the node 118 is an element-wise layer having inputs from multiple nodes such that pruning information for the node 118 may depend on prunable parent nodes of that node (the nodes 112 and 114). Thus, analyzing the node 132 for pruning may require pruning information corresponding to the nodes 126, 128, 112, 114, and 116, as indicated in the list 142D for the node 132.

Using conventional approaches, when exploring the node 132 to determine the pruning information for analyzing the node 132 (e.g., to determine the elements of the list 142D), a recursive call to a function may be performed on each parent node of determine the pruning information for the parent node. Thus, for example, when exploring the node 132, a call may be made to explore the nodes 126, 128, and 130. While the calls for nodes 126 and 128 may terminate as they represent prunable layers, when a node that represents layers having inputs from multiple parent layers is encountered, a recursive call to the function may again be performed for each parent layer, such as for the nodes 122 and 116 for the node 130. This process may continue for parent nodes that correspond to layers having inputs from multiple parent nodes (e.g., for the nodes 122 and 118).

In at least one embodiment, the data identifying pruning information for a visit to one node may be used by another node. For example, for a visit to the node 132, the list 142C may be used to identify pruning information to analyze the node 132. For example, in embodiments where the node 130 is visited prior to the node 132 (e.g., where the node 130 is fully explored), a similar process as described above for determining the list 142D may have already been performed to determine the list 142C for the node 130. As the list 142C may correspond to pruning information for the node 130, the pruning information for the node 130 may be reused for the node 132. Thus, work performed for a visit to the parent (the node 130) may be reused for the visit to the child (the node 132). In at least one embodiment, determining data identifying at least some of the pruning information for the node 132 may include incorporating one or more portions of the list 142C into the list 142D. Similarly, as indicated in FIG. 1, if the nodes 118 and 122 are visited prior to the node 130, work from those visits may be reused for the node 130. As an example, the list 142C for the node 130 may be determined from the list 142A and/or 142B.

Thus, in at least one embodiment, when exploring a node, rather than always visiting each parent of the node in the deep learning model 106A to determine and/or identify pruning information for the parent node, the model explorer 102 may reuse at least some of the work performed for visiting the parent node in the same and/or a different traversal of the deep learning model 106A. For example, the model explorer 102 may use—for one or more child nodes—at least a portion of a list 142 generated for the parent node(s), selections of one or more connections and/or parameters to prune from and/or retain in the parent node(s), and/or a data object(s) 140 generated for the parent node(s).

In at least one embodiment, the model explorer 102 may store, for a first visit to a first node of the nodes, at least a portion of pruning information in one or more of the data objects 140. For a second visit to a second node of the nodes, the pruning information from the data object(s) 140 may be accessed based at least on the first node being a parent of the second node. Additionally, or alternatively, the model explorer 102 may generate, for the first visit to the first node, a list of parent nodes of the first node. The model explorer 102 may incorporate, for the second visit to the second node, the list of parent nodes of the first node in a list of parent nodes of the second node and use the list of parent nodes of the second node to access pruning information for the second node. Thus, the first node need not be revisited for the visit to the second node and/or at least some of the work performed for the first visit can be re-used.

In at least one embodiment, a visit to a node may include the model explorer 102 marking the node as visited or otherwise storing data indicating a visit to the node. In at least one embodiment, the visit to the node may include for at least one parent node of the node (e.g., each parent of the node), determining whether the parent node has been visited (e.g., is marked or otherwise indicated as visited or explored using one or more passes through one or more nodes of the deep learning model). In at least one embodiment, based at least on the parent node having been visited (e.g., explored using one or more passes through one or more nodes of the deep learning model), the model explorer 102 may reuse at least some of the pruning information determined and/or identified for the parent node. For example, the model explorer 102 may incorporate at least a portion of a list 142 of parent nodes of the parent node in a list of parent nodes of the node being visited or otherwise use data indicating pruning information for the parent node. In at least one embodiment, determining a visit to a node has already occurred may indicate that the node has been fully explored (e.g., all prunable parent nodes of the node, if any, have been visited using one or more passes through one or more nodes of the deep learning model), the list 142 for the node is complete, the node has been analyzed for pruning, and/or the pruning information includes all information from the parent node(s) needed by the child node for pruning the child node.

As described herein, the reused pruning information may be used to analyze the node for pruning. In at least one embodiment, the reused pruning information may be used to select connection(s) and/or parameter(s) to prune based on the node being visited. For example, the model explorer 102 may use a list 142 for the node to identify and access pruning information stored in the data object(s) 140 for each prunable parent node of the node. In at least one embodiment, the visit may include storing the selected connection(s), parameter(s), and/or other results of analyzing the node for pruning (e.g., a determination to not prune a connection(s) and/or parameter(s)) in a data object 140 corresponding to the node being visited (e.g., data indicating one or more retained output indices). In at least one embodiment, the visit may include based at least on determining a parent has not been visited, visiting the parent. In at least one embodiment, the visit to the parent may be similar to the visit to child. For example, visiting the parent may be part of a recursive call to a visit or exploration function for a node (e.g., the recursive graph traversal algorithm).

In at least one embodiment, when a recursive algorithm is used to explore the nodes, by determining the parent node has already been visited and reusing work from the visit, one or more branches of the recursive algorithm can be bypassed and/or executed using a reduced workload (e.g., the parent node need not be analyzed again for pruning and/or a list of prunable parent nodes need not be generated again and/or in full for the parent node, etc.), thereby saving computational resources. One or more embodiments of the present disclosure may use dynamic programming to recursively explore the deep learning model 106A while reusing work performed during one or more iterations of the recursion in one or more other iterations of the recursion. For example, in accordance with one or more embodiments of the disclosure, each time a node is visited, the model explorer 102 need not visit and determine and/or identify pruning information for each parent of that node. Further, as described herein, in at least one embodiment, the pruned model generator 104 may use at least some of the determined and/or identified pruning information to generate the pruned model 106B. Thus, the pruned model generator 104 may generate the pruned model 106B more efficiently than otherwise possible.

In at least one embodiment, the model explorer 102 may start at each input node, such as the input node 110, and create a queue with the input node. The model explorer 102 may pop the node from the queue and determine the node type of the node (e.g., determine whether the node is prunable and/or whether the node is a convolutional layer or an element-wise layer). If the model explorer 102 determines the node is prunable, the model explorer 102 may analyze the node for pruning, which may use a pruning threshold and/or other criteria, to determine data indicating one or more retained indices for the kernel. Otherwise, the model explorer 102 may determine the list 142 for the node. In one or more embodiments, the list 142 for the node may be determined based at least on backtracking the nodes that provide inputs to the current node until the first prunable nodes are found. Once found, equalization may be performed and used to determine the retained indices providing input to the current node. As described here, at least some of the backtracking may be avoided based on determining a parent have already been visited. The output layers of the popped node may be added to the queue and the process may be repeated until the queue is empty.

In at least one embodiment, the pruned model generator 104 may perform pruning operations on each layer and/or node of the deep learning model 106A using a tree traversal algorithm, such as a breadth-first search algorithm. Other tree traversal algorithms may be used, such as a depth-first search algorithm. When visiting a node, the pruned model generator 104 may use a list 142 for the node to access the data object(s) 140 for one or more parent nodes of the node. In at least one embodiment, the order of the parent nodes in the list 142 (e.g., defined by the traversal order used by the model explorer 102 when generating the list 142) may be used to determine the order in which the pruned model generator 104 analyzes the parent nodes. For example, the pruned model generator 104 may iteratively pop the list 142 starting from the input node to gradually reconstruct the node and/or layer based at least on the connection(s) (e.g., outputs) and/or parameter(s) that is to be retained according to the pruning information (e.g., using indices of retained and/or cut connections that are stored in the pruning information) for the popped node and/or layer.

In at least one embodiment, the pruned model generator 104 may traverse the graph using a similar approach as the model explorer 102. For example, a queue may be populated with an input node(s) which is popped and analyzed, then any output nodes may be added to the queue and the process may repeat. In at least one embodiment, if a layer is pruned or prunable, the pruned model generator 104 may update the kernel if the layer based on the retained indices for the inputs to the layer and the retained indices of the current layer. The graph may then be reconstructed with the pruned layers.

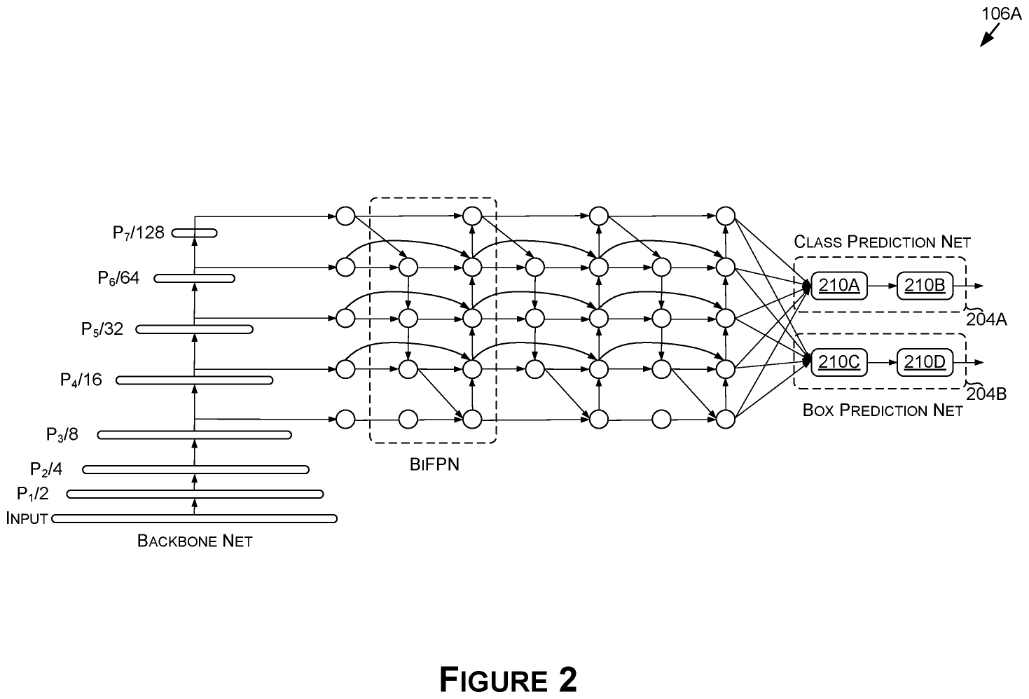

Referring now to FIG. 2, FIG. 2 illustrates an example of the deep learning model 106A that may be pruned, in accordance with some embodiments of the present disclosure.

The deep learning model 106A of FIG. 2 may be comprise a single-stage object detector including a weighted Bi-directional Feature Pyramid Network (BiFPN) and feature fusion. As the deep learning model 106A of FIG. 2 integrates bidirectional cross-scale connections and is jointly scaled up in width and depth, when evaluating a node for pruning, pruning information for a parent node may be frequently needed. Without reusing work performed when visiting a parent node—in accordance with aspects of the present disclosure—the deep learning model 106A of FIG. 2 may take approximately 12 hours to prune. To provide a non-limiting example of a performance improvement that may be achieved when reusing work, the deep learning model 106A of FIG. 2 may take the same processing components approximately 90 minutes to prune.

The deep learning model 106A of FIG. 2 also includes subnets 204A and 204B. The subnet 204A may include a class prediction network for classification of one or more detected objects (e.g., to predict the probability of object presence). The subnet 204B may include a box prediction network for localization of one or more detected objects (e.g., to predict an offset of the object at each spatial position for each anchor). The subnets 204A and 204B may include a convolutional network (e.g., a fully convolutional network) attached to a corresponding BiFPN level. For example, the convolutional network for the subnet 204A may include a convolutional layer 210A and a convolutional layer 210B, and the convolutional network for the subnet 204B may include a convolutional layer 210C and a convolutional layer 210D.

Each of the output features from a corresponding level of the BiFPN may be connected to at least the first convolutional layer in the subnet. This approach may allow, the subnets 204A and 204B to effectively learn features from multiple (e.g., all) resolutions at the same time. However, conventional pruning algorithms may be unable to prune the deep learning model 106A, as the number of channels of P3 to P7 after pruning can be quite different while the next convolutional layer always remains the same. In particular, conventional pruning algorithms may be unable to prune inputs to convolutional layers, such as the convolutional layer 210A or the convolutional layer 210C, that have inputs from multiple nodes and/or correspond to multiple dependent convolutions performed using the inputs.

In one or more embodiments, a convolutional layer that has inputs from multiple nodes may be explored similar to an element-wise layer, allowing for pruning inputs to the convolutional layer. Further, a layer that include multiple dependent convolutions, such as a separable convolutional layer, may be pruned by treating each convolution as a separate node and/or layer.

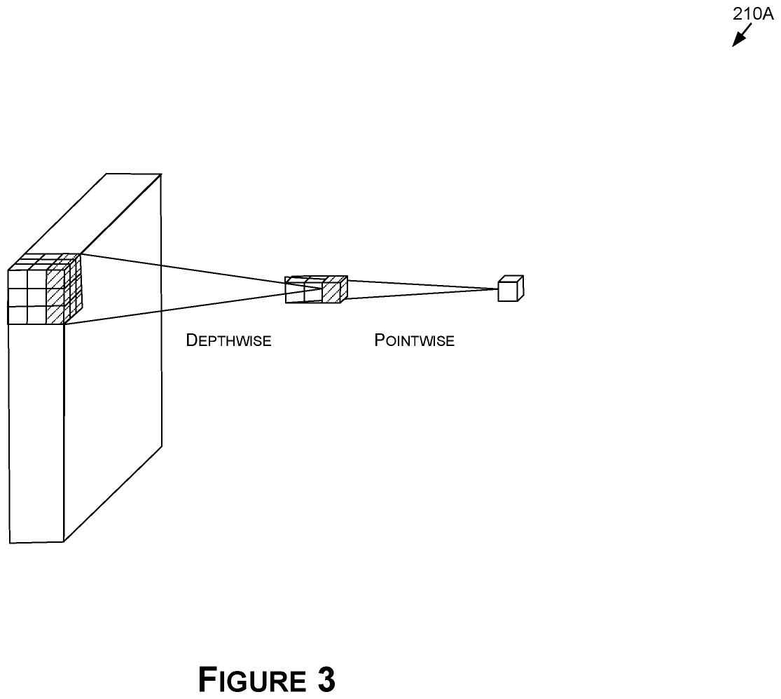

Referring now to FIG. 3, FIG. 3 illustrates an example of the convolutional layer 210A of the deep learning model 106A that may be pruned, in accordance with some embodiments of the present disclosure. The convolutional layer 210A corresponds to a separable convolutional layer including multiple convolutions. For example, the convolutional layer 210A of FIG. 3 includes a depthwise convolution and a pointwise convolution. Pruning the inputs to the convolutional layer 210A may result in incompatibilities between the dependent convolutions. For example, the pointwise convolution may use information produced by the depthwise convolution, which may no longer be available after pruning. Thus, conventional pruning algorithms are unable to prune layers that include dependent convolutions.

In accordance with aspects of the disclosure, a layer having dependent convolutions, such as a separable convolutional layer, may be pruned based at least on evaluating each convolution as a respective node and/or layer of the deep learning model 106A. For example, model explorer 102 may treat the convolutional layer 210A of FIG. 3 as a combination of a depthwise convolutional layer and a 1×1 regular convolutional layer and explore the convolutional layer 210A as a potential element-wise operation. This approach may be used for any layer containing a shared computational kernel, such as, a transposed convolutional 2D layer.

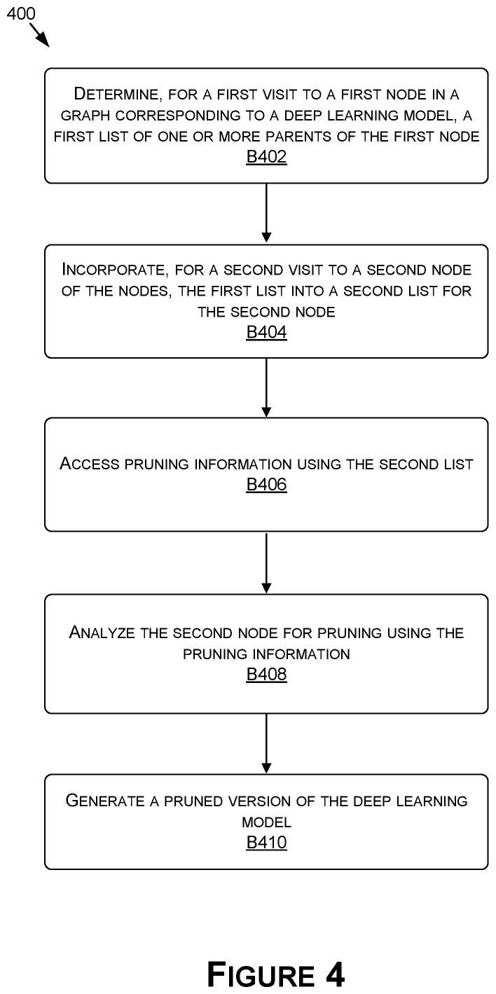

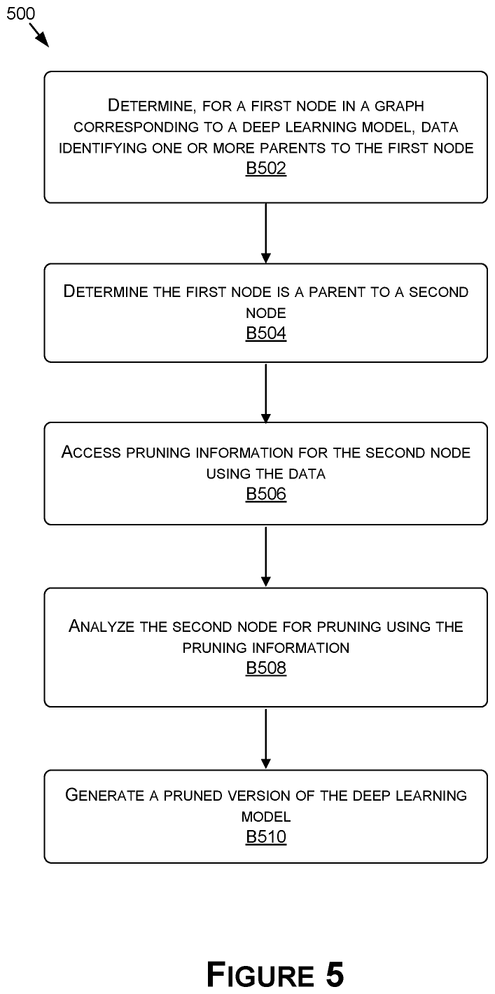

Now referring to FIGS. 4-5, each block of method 400, and 500, and other methods described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods are described, by way of example, with respect to particular figures. However, the methods may additionally or alternatively be executed by any one system, or any combination of systems, including, but not limited to, those described herein.

FIG. 4 is a flow diagram showing a method 400 for exploring a graph corresponding to a deep learning model based on reusing data, determined for a visit to a node, that identifies pruning information for the node, to access the pruning information for analyzing another node for pruning, in accordance with some embodiments of the present disclosure. The method 400, at block B402, includes determining, for a first visit to a first node in a graph corresponding to a deep learning model, a first list of one or more parent nodes of the first node. For example, the model explorer 102 may explore a graph comprising nodes corresponding to layers of the deep learning model 106A and edges corresponding to connections between the layers of the deep learning model 106A. The exploring may include the model explorer 102 determining, for a visit to the node 130 of the nodes, the list 142C.

At block B404, the method 400 includes incorporating, for a second visit to a second node of the nodes, the first list into a second list for the second node. For example, the model manager 102 may incorporate the list 142C into the list 142C.

At block B406, the method 400 includes accessing pruning information using the second list. For example, the model manager 102 may use the list 142D to access pruning information for the nodes 126, 128, 112, 114, and 116.

At block B408, the method 400 includes analyzing the second node for pruning using the pruning information. For example, the model explorer 102 may analyze, using the pruning information accessed using the list 142D, the node 132 for pruning.

At block B410, the method 400 includes generating a pruned version of the deep learning model. For example, the pruned model generator 104 may generate the pruned model 106B based at least on one or more results of the analyzing.

Referring now to FIG. 5, FIG. 5 is a flow diagram showing a method 500 for exploring a graph corresponding to a deep learning model based on using a list of one or more parents, generated for a visit to a node, that indicates pruning information for the node, to access the pruning information for analyzing another node for pruning, in accordance with some embodiments of the present disclosure. The method 500, at block B502, includes determining, for a first node in a graph corresponding to a deep learning mode, data identifying one or more parent nodes of the first node. For example, the model explorer 102 may determine, for the node 130 of the nodes, the list 142C.

At block B504, the method 500 includes determining the first node is a parent of the second node. For example, the model manager 102 may determine the node 130 is a parent of the node 132.

At block B506, the method 500 includes accessing pruning information for the second node using the data. For example, the model manager 102 may access pruning information for the node 132 using the list 142C.

At block B508, the method 500 includes analyzing the second node for pruning using the pruning information. For example, the model explorer 102 may analyze the node 128 for pruning using the pruning information accessed using the list 142C.

At block B510, the method 500 includes generating a pruned version of the deep learning model. For example, the pruned model generator 104 may generate the pruned model 106B based at least on results of the analyzing the node 132 for pruning.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, included wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark' (hereinafter “Spark”) that may utilize distributed file system 738 for large-scale data processing (e.g., “big data”). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C .R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
determining, for a graph comprising a plurality of nodes corresponding to layers of a deep learning model, a first list of one or more prunable parent nodes of a first node during a first pass through the plurality of nodes, the first pass including at least- the first node; and
incorporating, for a second pass that includes a second node of the plurality of nodes, the first list of one or more prunable parent nodes of the first node into a second list of one or more prunable parent nodes of the second node based at least on the first node being a parent of the second node;
accessing pruning information for at least one prunable parent node of the second node based at least on the second list;
analyzing, using the pruning information accessed using the second list, at least one connection to at least one layer corresponding to the second node for pruning; and
generating a pruned version of the deep learning model based at least on one or more results of the analyzing the at least one connection for pruning.

2. The method of claim 1, wherein at least the second pass is performed for a recursive graph traversal algorithm, and one or more branches of the recursive graph traversal algorithm are bypassed based at least on determining, for the second pass, that the first pass has occurred.

3. The method of claim 1, wherein the generating the pruned version of the deep learning model includes updating one or more weights of one or more layers of the layers of the deep learning model based at least on the one or more results.

4. The method of claim 1, wherein the pruning information indicates at least one result of analyzing the at least one prunable parent node for pruning, and the analyzing the at least one connection is based at least on the at least one result.

5. The method of claim 1, wherein the second list of one or more prunable parent nodes indicates at least one pointer to at least one data object storing the pruning information for the at least one prunable parent node, and the accessing the pruning information uses the at least one pointer to access the at least one data object.

6. The method of claim 1, wherein the incorporating the first list into the second list is based at least on the first node comprising inputs from at least two nodes of the nodes.

7. The method of claim 1, wherein the pruning information corresponds to each prunable parent node of the first node.

8. The method of claim 1, further comprising:
determining, for the second pass, that a third pass for a third node has not already occurred based at least on the third node being a parent of the second node;
based at least on the determining the third pass has not already occurred, performing the third pass, wherein a third list of one or more prunable parent nodes is determined for the third node; and
incorporating the third list of one or more prunable parent nodes into the second list.

9. The method of claim 1, wherein the second list includes a plurality of parent nodes, and the analyzing the at least one connection includes combining inputs to the second node across the plurality of parent nodes.

10. The method of claim 1, wherein the second node includes one or more of an element-wise layer or a convolutional layer that has inputs from multiple nodes.

11. The method of claim 1, wherein a layer of the layers corresponds to a first convolution having inputs from at least two of the nodes and a second convolution having one or more inputs from the first convolution, and wherein the first node corresponds to the first convolution and the second node corresponds to the second convolution.

12. A system comprising:
one or more circuits to perform operations including:
determining, for a first node of a graph including a plurality of nodes and corresponding to layers of a deep learning model, data identifying one or more parent nodes of the first node;
determining the first node is a parent node of a second node of the nodes;
based at least on the first node being determined as a parent of node of the second node, accessing pruning information for the one or more parent nodes for the second node using the data identifying the one or more parent nodes of the first node;
analyzing the second node for pruning using the pruning information accessed using the data identifying the one or more parent nodes of the first node; and
generating a pruned version of the deep learning model based at least on results of the analyzing the second node for pruning.

13. The system of claim 12, wherein the pruning information indicates at least one first connection of the deep learning model selected for pruning based on analyzing the one or more parent nodes for pruning and the analyzing the second node for pruning includes selecting at least one second connection of the deep learning model for pruning based at least on the at least one first connection being selected for pruning.

14. The system of claim 12, wherein at least the determining the data identifying the one or more parent nodes of the first node is performed for a pass of a recursive graph traversal algorithm, and one or more calls to the recursive graph traversal algorithm are bypassed based at least on determining, for the second node, that the pass has occurred.

15. The system of claim 12, wherein the pruning information indicates a nearest prunable parent node layer to the second node.

16. The system of claim 12, wherein the operations further include causing deployment of the pruned version of the deep learning model in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system for presenting at least one of virtual reality content, augmented reality content, or mixed reality content;
a system implemented at least partially in a data center; or
a system implemented at least partially using cloud computing resources.

17. A processor comprising:
one or more circuits to generate a pruned version of a deep learning model based at least on analyzing pruning information for one or more parent nodes of a first node of nodes of a graph corresponding to the deep learning model using a list of the one or more parent nodes of the first node identified in a first visit to the first node, at least a portion of the list being generated for a second visit to a second node of the nodes prior to the first visit to the first node.

18. The processor of claim 17, wherein at least the first visit is performed for a recursive graph traversal algorithm, and one or more branches of the recursive graph traversal algorithm are bypassed based at least on determining, for the first visit, that the second visit has occurred.

19. The processor of claim 17, wherein the pruned version of the deep learning model is generated based at least on updating one or more weights of one or more layers of the deep learning model based at least on results of the analyzing the pruning information.

20. The processor of claim 17, wherein the one or more circuits are further to cause deployment of the pruned version of the deep learning model in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system for presenting at least one of virtual reality content, augmented reality content, or mixed reality content;
a system implemented at least partially in a data center; or
a system implemented at least partially using cloud computing resources.
